(19) United States
(12) Patent Application Publication
(10) Pub. No.: US 2019/0012854 A1
(43) Pub. Date: Jan. 10, 2019

(54) SYSTEM FOR PROVIDING NOTIFICATION OF A VEHICLE EVENT

(71) Applicant: FORD GLOBAL TECHNOLOGIES, LLC, Dearborn, MI (US)

(72) Inventors: Vicki NOONAN, Hutton Essex (GB); Brian G. RUTTER, Winchmore Hill London (GB)

(73) Assignee: FORD GLOBAL TECHNOLOGIES, LLC, Dearborn, MI (US)

(21) Appl. No.: 16/031,765

(22) Filed: Jul. 10, 2018

(30) Foreign Application Priority Data
Jul. 10, 2017 (GB) 1711048.7

(51) Int. Cl. G07C 5/08; G07C 5/00; F02D 41/02

(52) U.S. Cl. CPC G07C 5/0816; G07C 5/008; G07C 5/0808; H04W 4/40; F02D 41/029; F02D 2200/0812; F02D 41/0245

(57) ABSTRACT

A system including a vehicle control unit configured to detect a vehicle event and a communication unit configured to transmit a notification from the vehicle control unit to a mobile device, the notification including both an identification of the vehicle event and instructions on how to enact a specific driving task to reverse a condition associated with the detected event.

### CROSS-REFERENCE TO RELATED APPLICATIONS

This application claims foreign priority benefits under 35 U.S.C. § 119(a)-(d) to GB Application 1711048.7 filed Jul. 10, 2017, which is hereby incorporated by reference in its entirety.

### TECHNICAL FIELD

The illustrative embodiments relate to a system for providing notification of a vehicle event, such as, although not limited to, notification of the need to regenerate the vehicle's Diesel Particulate Filter.

### BACKGROUND

Diesel Particulate Filters have been a legal requirement in all passenger vehicles since 2009 in the UK. The legislation was introduced to help cut particle emissions from diesel vehicles to curb the known effect of vehicle emissions on the environment. All diesel passenger vehicles first registered in the UK since 2009 have a Diesel Particulate Filter installed within the exhaust system.

During combustion of diesel fuel, small particles of soot are formed and expelled from the diesel engine through the exhaust system. The Diesel Particulate Filter traps these soot particles and effectively reduces soot emissions from the vehicle. As with any filter, Diesel Particulate Filters require regular emptying, otherwise they can become blocked, which actually increases soot emissions from the vehicle. This can negatively affect performance, and, in some cases, make the vehicle undriveable.

In most vehicles, an engine warning light will show on the dashboard when the Diesel Particulate Filter is partially full. The engine warning light indicates to the driver that the Diesel Particulate Filter needs emptying.

Emptying of the Diesel Particulate Filter is known as regeneration. There are three broad categories of regeneration.

Passive regeneration is a process of burning off excess soot trapped within the Diesel Particulate Filter during normal driving conditions. For this process to occur, the vehicle needs to be driven for a minimum of 30-50 minutes at a sustained speed in order for the temperature of the exhaust to be raised high enough to burn off the excess soot. A large number of drivers do not routinely travel long distances. Thus, passive regeneration may never, or at least rarely, occur in some vehicles.

Active regeneration is a process that can be initiated automatically by a vehicle's Engine Control Unit (or ECU) or manually by the driver. Active regeneration forces the exhaust to increase in temperature by introducing extra fuel into the engine to artificially raise the exhaust temperature. The process of active regeneration still requires the vehicle to be driven for a sustained period for the excess soot in the Diesel Particulate Filter to be burnt off.

Forced regeneration is a process that can be performed on the Diesel Particulate Filter to manually clean the excess soot from within the Diesel Particulate Filter. This process requires the driver to take the vehicle to a garage for cleaning, unless the driver is skilled enough to perform this process at home.

It is not unusual for drivers to simply clear, or ignore, error messages on the vehicle dashboard. Continuing to drive a vehicle with a blocked Diesel Particulate Filter will, over time, cause damage to the Diesel Particulate Filter which would require remedy through either forced regeneration or replacement of the Diesel Particulate Filter. In either case, the vehicle manufacture (or retailer) or vehicle owner would be responsible for the remedial costs. Remedial costs can be mitigated through passive and/or active regeneration of the Diesel Particulate Filter.

### SUMMARY

An aspect of the illustrative embodiments provides a system for providing notification of a vehicle event to an operator outside the vehicle. The system includes a vehicle control unit configured to provide a notification of the vehicle event. The system also includes a communication unit configured to transmit a notification from the vehicle control unit and an electronic device configured to receive a notification from the vehicle control unit. The electronic device further includes a user interface configured to provide instructions to the user to undertake specific driving conditions in order to mitigate the vehicle event.

Vehicle drivers often continue to drive their vehicles following notification that there may be some form of fault with the vehicle. For example, a light or icon will be shown on a vehicle dash board to signify a fault. Unless the driver is familiar with what the lights and/or icons mean, he/she is required to refer to a handbook to identify the fault or take the vehicle to a garage. In many cases drivers simply fail to identify the fault and continue to drive the vehicle until it exhibits physical symptoms, e.g., misfire, loss of performance, shuddering, etc., for example. Such an approach risks damaging the vehicle such that an expensive repair could be required, whereas, if the vehicle had been serviced shortly after the warning light or icon was displayed, any repair might be less complex and/or time consuming and consequently cheaper for the vehicle owner or warranty provider.

By providing instructions to the vehicle driver in the case of simple actions, it is more likely that the driver will undertake the necessary driving conditions to resolve the DTC code.

The vehicle event may be a blocked or full Diesel Particulate Filter. Examples will be given with respect to this event, but it will be appreciated that similar events, such as, but not limited to those mitigatable through changing driving behavior, can be similarly diagnosed and behavior can be similarly instructed.

In the case of a blocked or full Diesel Particulate Filter, continuing to drive the vehicle can result in the emissions increasing. In places such as the UK, where law mandates the limits, the rise can result in emissions above a legal limit. Emissions are tested during the vehicle's annual safety test, at least in the UK, but in the case of high mileage vehicles such as those used as taxis and for high mileage commuting, a vehicle can reach a mileage of 100,000 miles in just a few years or less. In such circumstances if a Diesel Particulate Filter has not been regenerated, and testing has not recently been performed, that vehicle can become a major pollutant and be driven unchecked until its first safety test.

The communication unit may transmit the notification by technologies like, but not limited to, BLUETOOTH, WI-FI, email, text message, dedicated software application or ANT+, for example.

As mobile communication reception is variable dependent on location, communication to a driver display device by more than one method may increase the chance of a message reaching a driver. For example, email and text message communication would require mobile communication reception whereas WIFI, Bluetooth and ANT+ simply require the ability of the electronic device to connect to the vehicle communication unit. Therefore, enabling multiple communication methods may result in increased system reliability.

A communication unit may transmit a further notification to a service provider advising of the vehicle event.

There will always be some drivers that will continue to ignore warning lights and icons and messages sent to an electronic device. Sending a report to a third-party service provider, i.e. a garage or warranty provider, provides an additional avenue for ensuring that the vehicle is serviced and/or repaired. Once the service provider receives the report or notification they can contact the owner to arrange service and/or repair. One method of contact can include contacting the owner of a device to which the message was also sent.

The electronic device may be configured to provide a status of the specific driving conditions in order to identify when the vehicle event has been mitigated.

It is human nature to want to complete onerous tasks as soon and as conveniently as possible. For a driver that commonly drives at low speed in urban areas for short journeys, a 30-50 minute drive on a very different type of road is a big change. This is particularly so in the case of older or disabled drivers. Nonetheless, the fact remains that a vehicle event may need mitigation. Taking the example of a blocked or full Diesel Particulate Filter or a depleted battery, specific driving conditions are required to mitigate the vehicle event. By providing a status of the effect that any mitigation actions are having, the system can allow the driver to clearly see when the event has been mitigated or if they need to keep performing the action, driving for longer.

The electronic device may be configured to transmit the status of the specific driving conditions to the vehicle communication unit, and communicate the status to the driver either visually or audibly by an in-vehicle display or speaker.

As using an electronic device while driving is now unlawful in many countries, it is useful for the electronic device to also transmit the status of the specific driving conditions to the vehicle communication unit. The status can then be displayed on an in-vehicle screen or audibly through the vehicle's entertainment system.

The electronic device may be configured to schedule a reminder for the user to undertake the specific driving conditions at specific intervals following a vehicle event based on an elapsed time period between vehicle events as determined by the vehicle control unit.

Rather than waiting for a recurring vehicle event to happen again in the future, the electronic device can be configured to schedule the user to undertake the specific driving conditions to mitigate the vehicle event before it happens. The vehicle control unit would store details of vehicle events and an elapsed time between such events occurring. Based on the vehicle's specific history, a reminder can be scheduled to notify the driver that certain driving conditions are required. This course of action would prolong the life of certain vehicle components such as Diesel Particulate Filters and batteries through preventative action rather than responsive action.

The vehicle control unit may be configured to determine whether the vehicle event has been mitigated and transmit a success or failure notification to the electronic device and/or third party service provider through the communication unit.

Transmission of a success or failure notification provides confirmation to the driver, fleet owner or service provider that the driver has successfully mitigated a vehicle event and/or that mitigation has been unsuccessful.

Transmission of a failure notification may trigger commencement of a mitigation process the next time the vehicle is driven.

In the case of certain vehicle events, e.g., a full or blocked Diesel Particulate Filter, some vehicles have a function to automatically mitigate the vehicle event. In this particular circumstance, commencement of active regeneration would adjust the engine characteristics in order to burn off any matter within the Diesel Particulate Filter.

The mitigation process may comprise injecting additional fuel into the vehicle engine to raise exhaust temperature.

Increasing the exhaust temperature effectively burns off any particulate matter within the Diesel Particulate Filter to regenerate it.

Another aspect of the illustrative embodiments provides a method of monitoring mitigation of a vehicle event, the method comprising: a) identifying that a vehicle event has occurred and generating a DTC code according to the identified vehicle event; b) communicating the vehicle event and/or DTC code to an electronic device; c) using the electronic device to locate instructions relating to the vehicle event and/or DTC code and how to mitigate the vehicle event; d) monitoring the vehicle activity to determine if the vehicle event has been mitigated; and e) clearing the DTC code when the vehicle event is identified as being mitigated.

Certain warnings generated by DTC codes can be manually cleared by the vehicle driver, while others require the vehicle to be plugged in to clear the DTC code. Either scenario is not satisfactory where a vehicle event associated with a DTC code can be cleared through driving the vehicle in a specified legal manner. By providing instructions to the vehicle driver and monitoring compliance with those instructions the vehicle control unit can determine when a certain vehicle event has been mitigated

The illustrative embodiments will now be described by way of reference to the following figures:

### BRIEF DESCRIPTION OF THE DRAWINGS

FIG. 1 shows a process diagram of how a system according to the present invention applies to a private vehicle owner; and

FIG. 2 shows a process diagram of how a system according to the present invention applies to a fleet vehicle owned by a corporate entity and driven by an employee.

### DETAILED DESCRIPTION

As required, detailed and illustrative embodiments are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Taking the non-limiting, illustrative scenario of a vehicle's Diesel Particulate Filter requiring regeneration, a Diagnostic Trouble Code (DTC code) is generated by a vehicle control unit to indicate that the Diesel Particulate Filter requires regeneration. An indication is provided within the vehicle to identify to the driver that an element of the vehicle requires attention. The indication may be as simple as a warning light on the vehicle's dashboard or more descriptive such as an image or text illustrating or describing the particular fault identified by the vehicle control unit.

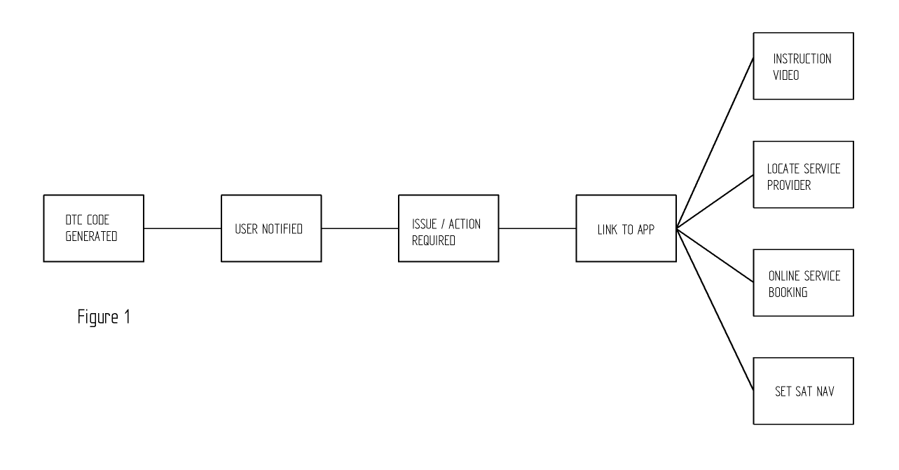

In the case of a private vehicle, as illustrated in FIG. 1, a message is sent to an electronic device explaining that the Diesel Particulate Filter requires regeneration. The message could be sent as a text message or email or to a dedicated software application and could be transmitted by way of BLUETOOTH, WI-FI or ANT+, for example. The message would be sent to the electronic device once the vehicle is stationary and the vehicle engine is turned off. In the case of vehicles fitted with an integral navigation unit, the text message might only be sent when the vehicle is determined as being at the owner's residence or place of work. In such a scenario, if the vehicle is not determined as arriving at the owner's residence or place of work for a pre-determined period of time, i.e 4 hours, the message might be sent to the electronic device at that time.

In conjunction with transmitting a message to an electronic device belonging to the owner, the communication unit might also send an additional message to a third-party service provider notifying the service provider of the requirement for regeneration of the Diesel Particulate Filter.

Returning to the message sent to an electronic device, the message could include a brief description of the issue to which the DTC code relates and any action required by the driver. The message would also include a link to a dedicated software application (assuming that the message is not already sent through a dedicated software application). By clicking on the relevant link, the user will be taken to the software application where they would be presented with a number of options relating to the issue.

In particular, the user may be directed to view a video or animation stored in the cloud or on a social media platform. The video may provide instructions to the user on how to perform passive regeneration of the Diesel Particulate Filter. For example, drive the vehicle for 50 minutes at 70 miles per hour. The software application could synchronize with the vehicle's on-board display and show a timer or percentage complete indicator such that the driver can identify when they have completed the regeneration process in accordance with the instructions provided on the software application without referring to the electronic device while driving. The electronic device would also show a message confirming completion of regeneration. The electronic device can also be instructed manually by the user or automatically to schedule a future Diesel Particulate Filter regeneration drive. Such functionality would pre-empt the Diesel Particulate Filter becoming blocked or full.

If the DTC code is not resolved within a pre-determined time, the communication unit of the vehicle can be configured to issue a further notification to a third-party service center to indicate that the Diesel Particulate Filter has not regenerated. This notification provides the third-party service center with the ability to contact the vehicle driver directly by standard communication methods such as phone, email or text or through the dedicated software application.

A further option for the user of the electronic device would be to select an option to navigate directly to a third-party service provider if, for example, the vehicle enters a “safe” mode and its performance is limited to avoid further damage to the Diesel Particulate Filter and/or engine. Upon selecting this option the electronic device could synchronize with a navigation system connected to the vehicle to facilitate navigation to the third party service provider without reference to the electronic device.

The user of the electronic device may also wish to book into a third-party service provider to have the vehicle serviced and/or repaired. The electronic device could provide the option for the user of the electronic device to select a third-party service provider and book an appointment directly using the software application.

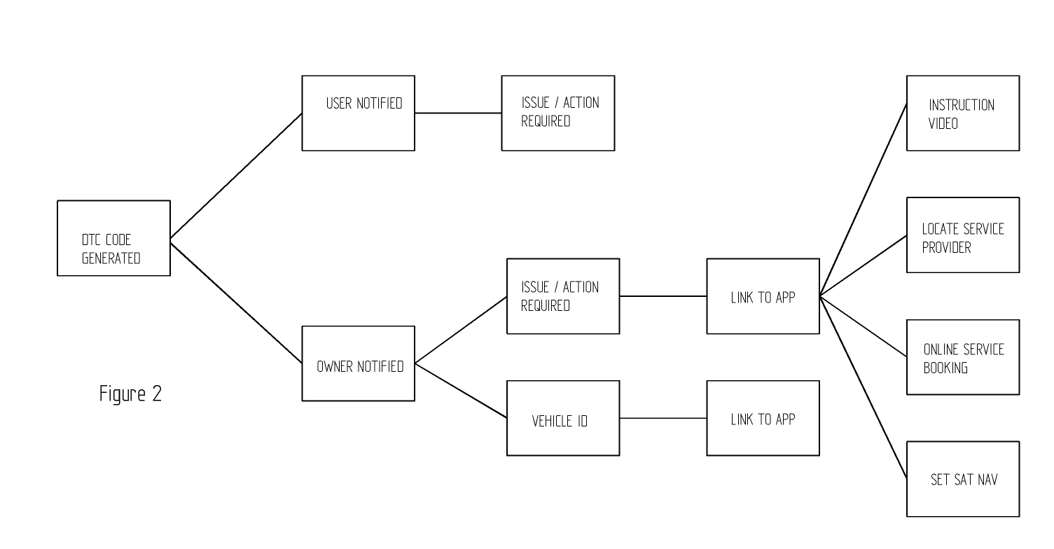

In the case of a fleet vehicle, as illustrated in FIG. 2, a DTC code is generated by the vehicle control unit and a message is sent to an electronic device registered to the driver of the vehicle. In this scenario the driver would simply receive a brief description of the issue and the action required to resolve. The driver would be directed to contact their fleet manager to arrange the necessary service or repair.

The fleet manager would receive a separate message via an electronic device registered to the fleet owner. This message would be as per that received by the vehicle driver but would also identify the vehicle affected. In the case of a fleet vehicle with GPS tracking enabled the fleet manager might also receive a location of the vehicle and the contact details of the driver such that the driver can be instructed to take the vehicle to a specified location for service and/or repair.

The message received by the fleet manager would be as per that received by the private vehicle owner in the previous example and the software application is the same. A fleet manager might also have an additional option on the software application to track service history of all fleet vehicles, identify any vehicles that have an unresolved DTC code and arrange and track service and/or repair of all vehicles in the fleet.

Although the two given examples relate to Diesel Particulate Filter regeneration, the present invention is equally applicable to other vehicle events that result in generation of a DTC code and require an action to resolve the DTC code.

The foregoing description is not intended to limit the scope of the invention and is given by way of example only. The description should be used simply to interpret the claims without undue limitation.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a vehicle control unit configured to detect a vehicle event; and
a communication unit configured to transmit a notification from the vehicle control unit to a mobile device, the notification including both an identification of the vehicle event and instructions on how to enact a specific driving task for a vehicle to reverse a condition associated with the detected event.

2. The system of claim 1, wherein the vehicle event is a blocked or full Diesel Particulate Filter.

3. The system of claim 1, wherein the communication unit is configured to transmit a further notification, advising of the vehicle event, to a service provider.

4. The system of claim 1, wherein the notification is transmitted by the communication unit by way of one or more communication methods including at least one of Bluetooth, WIFI, email, text message, dedicate software application, or ANT+.

5. The system of claim 1, wherein the vehicle is configured to provide ongoing completion status of the specific driving task to identify when the vehicle event has been mitigated.

6. The system of claim 5, wherein the vehicle is configured to communicate the completion status to a driver either visually or audibly by an in vehicle display or speaker.

7. The system of claim 1, wherein the vehicle control unit is configured to determine when the vehicle event has been mitigated and responsively transmit a success or failure notification to the mobile device through the communication unit.

8. The system of claim 7, wherein transmission of a failure notification triggers commencement of a mitigation process a next time the vehicle is driven.

9. The system of claim 8, wherein the mitigation process comprises injecting additional fuel into an engine of the vehicle to raise exhaust temperature.

10. A computer-implemented method comprising:
identifying that a reversible vehicle event has occurred;
communicating the vehicle event to a mobile device;
using the mobile device to locate instructions relating to reversing the vehicle event;
monitoring vehicle activity to determine when the vehicle event has been reversed; and
clearing an event-associated DTC code when the vehicle event is identified as being reversed.

11. The method of claim 10, further comprising providing driving instructions to complete a driving task associated with event-reversal.

12. The method of claim 11, wherein the providing occurs on the vehicle.

13. The method of claim 11, wherein the providing occurs on the mobile device.

14. The method of claim 10, further comprising tracking driving task completion based on execution of a driving task using the vehicle.

15. The method of claim 14, further comprising outputting a completion status of the driving task.

16. The method of claim 15, wherein the completion status further indicates what portion of the driving task is complete, what portion remains, or both.

17. The method of claim 15, wherein the outputting occurs on the vehicle.

18. The method of claim 15, wherein the outputting occurs on the mobile device.

19. A computer-implemented method comprising:
responsive to detecting a reversible vehicle event:
presenting a driving task associated with event reversal,
presenting a visual display tracking completion of the driving task based on driving task execution in a vehicle in which the event occurred, and
removing the display following reversal of the vehicle event, reversal indicated by a state indicative of the vehicle event being returned to a pre-event state, or state equivalent, no longer indicating the event.
